(19) United States
(12) Patent Application Publication
(10) Pub. No.: US 2009/0313156 A1
(43) Pub. Date: Dec. 17, 2009

(54) Adaptive daily spending limits

(75) Inventor: Michael D. Herr, Huntersville, NC (US)

Correspondence Address: Wells Fargo;c/o K& L Gates, Hearst Tower, 47th Floor, 214 North Tryon Street, Charlotte, NC, 28202, US

(73) Assignee: Wachovia Corporation, Charlotte, NC (US)

(21) Appl. No.: 12/157,734

(22) Filed: Jun. 12, 2008

(51) Int. Cl. G06Q 40/00; G06F 17/00; G06K 5/00

(52) U.S. Cl. 705/35; 235/375; 235/380

(57) ABSTRACT

A computer-implemented system and method are provided for adapting the spending limit of a debit instrument in a networked computer system, particularly a daily spending limit. The method comprises determining or receiving notification of whether an electronic request to approve a debit instrument transaction was declined for exceeding a withdrawl limit or a spending limit, determining transactional risk associated with the debit instrument transaction using computer-implemented criteria, and adapting the spending limit of the debit instrument after the determination of transactional risk. Computer-implemented criteria are used to assess the transactional risk associated with a particular debit instrument transaction.

### FIELD OF THE INVENTION

The present invention relates to a system and method for adapting the daily spending limits of debit instruments.

### BACKGROUND OF THE INVENTION

Debit card transactions are a growing sector of the financial services transactions that occur today. Within the debit card industry, all consumer and business based debit cards tend to have daily spending limits associated with them. A daily spending limit refers to a top-end limit as to the amount of money that a cardholder can utilize with his or her debit card within a given day. These limits are arbitrary in that, the customer's available balance within their associated demand deposit account (DDA), is not considered in establishing this daily limit. These daily spending limits are utilized as a risk mitigant for the financial institutions that issue debit cards, to insulate the financial institutions in case of loss, theft and other fraud events that potentially could occur with that debit card. Historically, daily spending limits have been very rudimentary in their design.

In some cases, the debit card holder can request an increase in the established daily spending limit. However, those requests tend to be cumbersome in their handling. They are typically a completely manual process and are normally decisioned by an issuing institutions risk management parameters. Many of the decisions about whether to grant a request are based upon a customer's credit worthiness.

A common theme with historical practices relating to industry debit card daily spending limits is that they have typically been set without regard to any criteria or set based upon the card type that the customer is issued depending upon whether it is classic, gold, or platinum. Among the disadvantages associated with this structure are customer satisfaction issues. For example, a card holder becomes dissatisfied when legitimate transaction attempts made by the card holder are declined even when sufficient balance is available. This can result in an increase in operational expense to handle inquiries generated by the decline issuance and repeated issues eventually lead to customer attrition. Another disadvantage associated with historical practices is the loss of Interchange Revenue to the financial institution due to legitimate transactions being declined. Interchange Revenue is a charge assessed to a merchant for the completion of a transaction through a payment network. The fee is established by the governing card association such as VISA, Mastercard, or Discover and is based upon a certain percentage of the sale. Interchange fees are variable. In many cases, other payment devices or instruments are utilized to purchase the item originally attempted to be purchased with the debit card, including check, cash, ACH debit or another access device or instrument. Still yet another disadvantage is potential loss of wallet share as the debit card becomes a secondary payment option. Still yet another disadvantage of historical practices with respect to debit cards is too much risk exposure for an individual card portfolio and revenue growth opportunity is lost because of spending limit controls.

If daily point of sale (POS) spending limits are established at too high of a level, a card portfolio is exposed to incrementally higher risk. If limits are established at too low of a level, profitability is not maximized as potential sales volume is lost. Additionally, customer perception is negatively impacted, as point of sale declines occur.

Thus, there is a need to address these problems with debit instrument transactions. The present invention attempts to solve this need.

### SUMMARY OF THE INVENTION

The present invention relates to a computer-implemented system and method for adapting the spending limit of a debit instrument, particularly a daily spending limit, after a determination of transactional risk associated with the debit instrument transaction. The method generally comprises determining or receiving notification of whether an electronic request to approve a debit instrument transaction is declined for exceeding a withdrawl limit or a spending limit, determining transactional risk associated with the debit instrument transaction using computer-implemented criteria, and adapting the spending limit of the debit instrument after the determination of transactional risk. Computer-implemented criteria are used to assess the transactional risk associated with a particular debit instrument transaction. The criteria is capable of being generated for particular segments of debit instrument transactions.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram illustrating the overall environment in which the networked computer system and the method of the present invention operates.

FIG. 2 is a diagram illustrating the overall process flow for a debit instrument transaction using the method of the present invention to adapt the daily spending limits of a debit instrument.

FIG. 2A is a diagram illustrating an exploded view of the Merchant Acquirer/Payment Network shown in FIG. 2.

FIG. 2B is a diagram illustrating an exploded view of the Integrated Payment Engine shown in FIG. 2.

FIG. 3A is a flowchart illustrating the method of the present invention for adapting the daily spending limits of a debit instrument.

FIG. 3B is a flowchart illustrating the method of the present invention for adapting the daily spending limits of a debit instrument continued from FIG. 3A.

FIG. 3C is a flowchart illustrating the method of the present invention for adapting the daily spending limits of a debit instrument continued from FIG. 3B.

FIG. 3D is a flowchart illustrating the method of the present invention for adapting the daily spending limits of a debit instrument continued from FIG. 3C.

FIG. 3E is a flowchart illustrating the method of the present invention for adapting the daily spending limits of a debit instrument continued from FIGS. 3A, 3B, 3C, and 3D.

### DETAILED DESCRIPTION OF THE INVENTION

The following description of the preferred embodiment(s) is merely exemplary in nature and is in no way intended to limit the invention, its application, or uses.

The system and method of the present invention operates in a networked computer environment that is suitable for automated processing of debit instrument transactions.

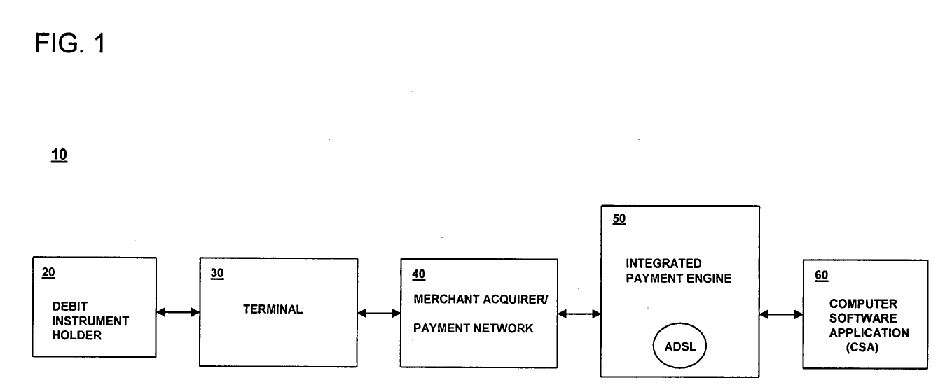

Referring to the figures, FIG. 1 is a diagram illustrating the overall environment in which the networked computer system and method for adapting the daily spending limits of a debit instrument of the present invention operates. As shown in FIG. 1, the system 10 of the present invention comprises a debit instrument holder 20, a terminal 30, a merchant acquirer/payment network 40, an integrated payment engine 50, and a computer software application 60. The components of system 10 are communicatively connected to one another such that data and information is exchanged between the components of the system 10 in order to facilitate an electronic debit instrument transaction.

The term “debit instrument holder,” as used herein, refers to the authorized user of a debit instrument, preferably the customer of a financial institution that issued the debit instrument.

The term “debit instrument,” as used herein, refers to any device that is used to make an electronic withdrawal from finds on deposit at a financial institution. A debit instrument may be used, for example, to withdraw cash at a bank such as at an automated teller machine (ATM), to pay for goods and services at POS, or a combination thereof. Preferably, the debit instrument is in the form of a debit card.

The term “terminal,” as used herein, refers to an automated teller machine (ATM) terminal, merchant terminal, or other vehicle for using a debit instrument.

The term “merchant acquirer,” as used herein, refers to the gateway connection that a merchant utilizes to establish connectivity to a payment network.

The term “payment network,” as used herein, refers to any computer system which facilitates an electronic payment and provides switching services between debit instrument issuers and merchant acquirers. An example of a payment network includes, but is not limited to, VISA Debit Processing Service (VDPS). The system and method of the present invention is not limited to a particular computer payment network.

The term “integrated payment engine,” as used herein refers to, a computer engine with capability to acquire, authenticate, route, switch, and/or authorize financial transactions across multiple channels or terminals. A non-limiting example of a commercially available software program that is suitable for use as an integrated payment engine in conjunction with the system and method of the present invention is BASE24 of ACI Worldwide, Inc. Preferably, the integrated payment engine comprises a means for automating and executing the adaptive daily spending limits methodology of the present invention.

The term “computer software application” or CSA, as used herein, refers to a computer software application that provides access to a financial account of a debit instrument holder.

The method of the present invention comprises receiving an electronic notification of a financial transaction conducted using a debit instrument of a debit instrument holder or a request to approve a financial transaction conducted using a debit instrument of a debit instrument holder, determining the transactional risk associated with the debit instrument transaction, and adapting the spending limit of the debit instrument. The method of the present invention is implemented as an automated computer-based method.

The term “transactional risk,” as used herein, refers to the risk associated with a monetary transaction. Transactional risk is derived from multiple sources including, but not limited to, a financial institution's experience with specific merchant categories and overall industry experience with losses by Standard Industrial Classification (SIC) code. Also, volumes, dispute validity, and recoverability of money involved in a transaction are factors. A significant factor associated with determining whether transactional risk is considered high or low is the preponderance of fraud in certain merchant categories. Generally, as the rate of fraud decreases, the higher the transactional risk that the method of the present invention tolerates in adapting daily spending limits of a debit instrument.

The term “spending limit(s),” as used herein, refers to the established spending limit(s) of a debit instrument at POS.

As indicated above, in order to determine transactional risk associated with a debit instrument transaction, the method of the present invention comprises establishing computer-implemented risk based guidelines or criteria for assessing when to allow spending limits of a debit instrument to be bypassed or overridden, preferably daily spending limits. For example, the daily spending limit of a debit instrument may be bypassed if the transactional risk is deemed to be low and if sufficient balance (i.e. adequate funds) exists in the associated demand deposit account (DDA) of the instrument holder to cover the purchase in full.

The system and method of the present invention is applicable to any industry and to a debit instrument transaction of any monetary amount or type. However, by way of non-limiting example, the method of the present invention is discussed with respect to U.S. currency and as applied to at least two segments of transactions in the debit industry, namely large dollar transactions and low dollar transactions. In accordance with the method of the present invention, a financial institution can make its own determinations as to what is considered “large dollar” versus “low dollar” based upon its own risk tolerance and experience. However, for illustrative purposes, large dollar transactions are typically transactions that due to a large amount of money being involved in a single transaction would begin to push a debit instrument holder over its daily spending limit. A financial institution might set, for example, a limit of $1000 or greater for a large dollar transaction. Low dollar transactions, for example, are transactions that by themselves are not considered large but could result in an instrument holder exceeding its daily spending limit because, for example, of already having completed a large dollar purchase within the same day. A financial institution might set, for example, a limit of $200 or less for a low dollar transaction.

The method of the present invention overrides the debit card authorization process to increase revenue through additional debit instrument use for high dollar transactions at low risk merchant locations. Whether a merchant location is considered low risk or high risk depends, for example, upon the level of fraud associated with a given SIC code. Transactions that are deemed over the daily spending limit are processed using the method of the present invention. The method of the present invention overrides the authorization process to allow the instrument holder increased spending limits at specified low risk merchant codes based on SIC code.

The method of the present invention comprises generating data tables for use in determining the transactional risk associated with a given debit instrument transaction. The data tables are referred to herein as adaptive daily spending limit (ADSL) tables. The ADSL tables are preferably fully integrated within the integrated payment engine. The ADSL tables comprise data that includes, but is not limited to, fraud, SIC (Standard Industry Code), debit instrument entry mode (i.e. swiped, keyed, etc.), geographic location of transaction such as country of origin, monetary amount of transaction, and a combination thereof. SIC codes are four digit numerical codes assigned by the U.S. Government to business establishments to identify the primary business of the establishment. The first two digits of the code identify the major industry group, the third digit identifies the industry group, and the fourth digit identifies the industry. Comparable metrics could be employed for other foreign jurisdictions.

The method of the present invention further comprises generating ADSL tables to target specific segments of debit instrument transactions. For example, a first segment is single or multiple large dollar transactions, originating from low risk SIC codes that negatively interact with the card limit thresholds. Example is a $12,000 purchase from a high-end automobile dealership on a card with a $5,000 daily spending limit. Example is a $800 purchase from a doctor's office after the instrument holder completed several other purchases during the day totaling $2900 on a card with a $3000 daily spending limit. A second segment is for lower dollar transactions, referred to generally as a cushion segment, from most SIC codes that exceed by a small margin the daily spending limit of a debit card. Example is a $125 grocery store purchase completed after the instrument holder completed a $2950 furniture store purchase earlier in the day on a card with a $3000 daily spending limit.

The method of the present invention provides for logging the transaction by type. For example, “U” may be used to represent Ultra Dollar Segment transactions. “H” may be used to represent High Dollar Segment transactions. “C” may used to represent Cushion Dollar Segment transactions. Each of these segments may be further identified as being associated with business or consumer usage.

There is an unlimited number or segments that could be identified by SIC code to generate ADSL data tables for use in the system and method of the present invention. Furthermore, numerous operating assumptions may be implemented such as the ability to adapt daily spending limits is only applicable to debit instrument holders who have sufficient account balances available to cover the previously declined authorization requests. Another operating assumption is that the ADSL applies to certain authorization requests of a particular geographic origin. Still yet another operating assumption is that ADSL only applies to swiped authorization requests as opposed to keyed or vice versa.

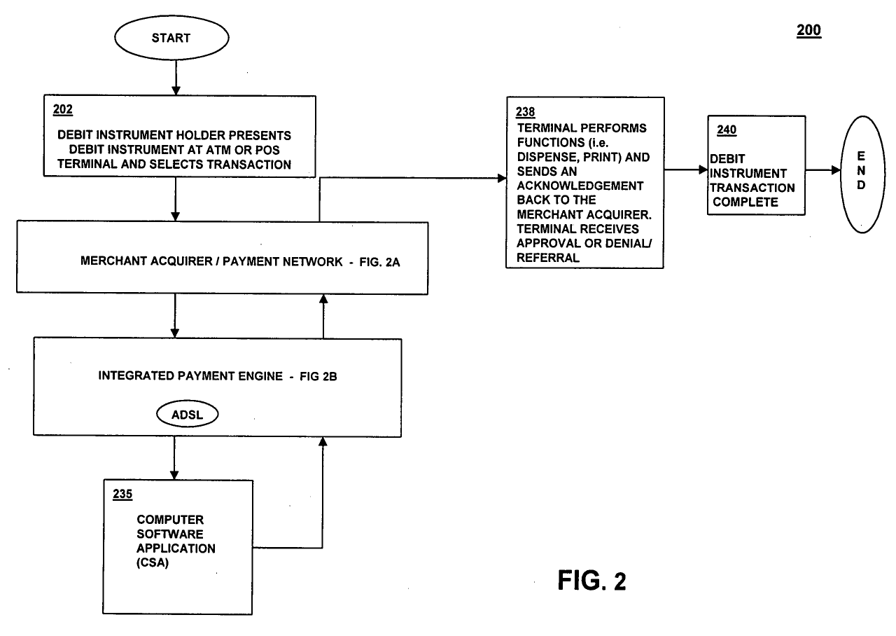

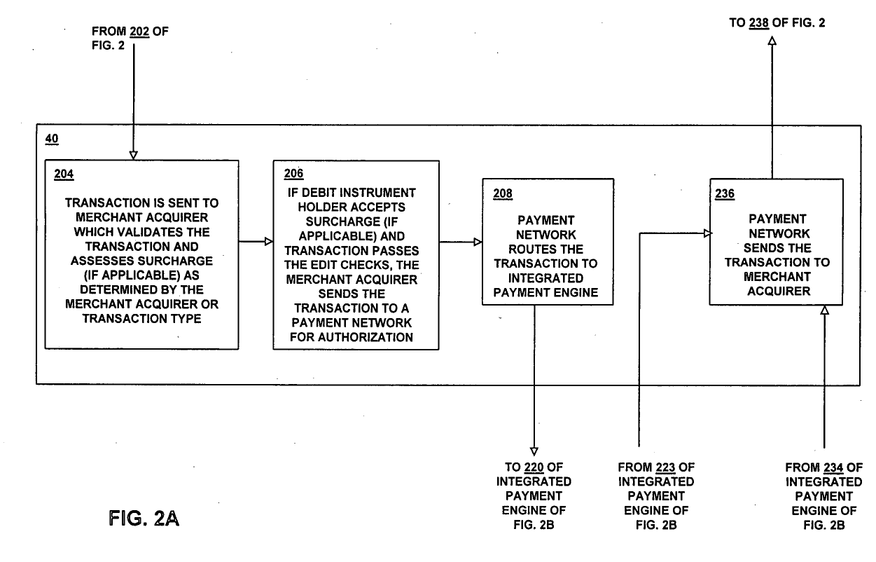

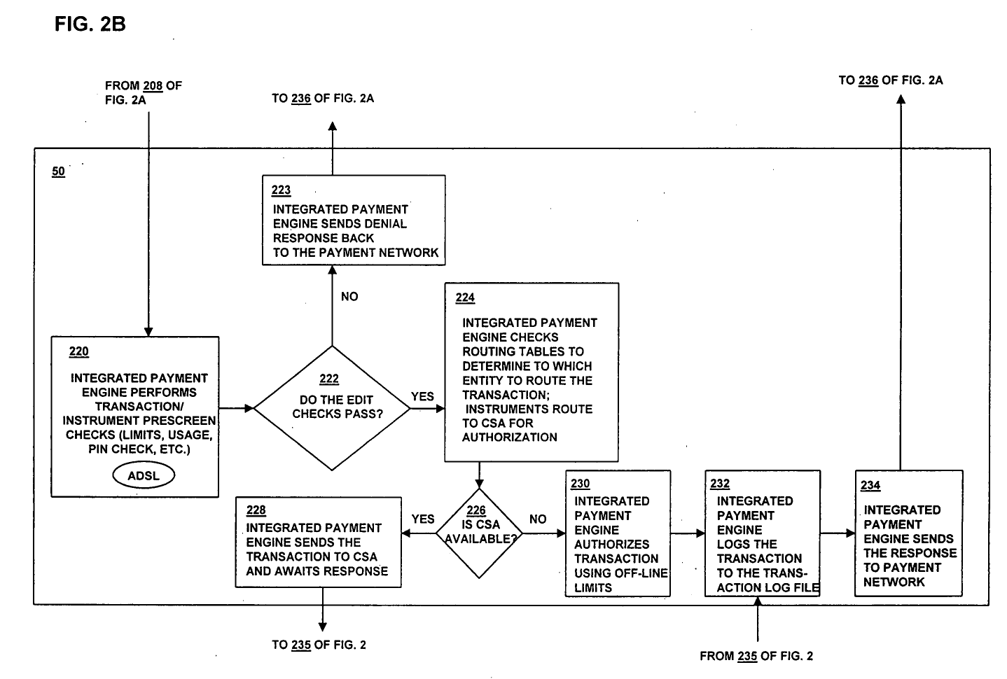

Referring to the figures, FIG. 2 is a diagram illustrating the overall process flow 200 for a debit instrument transaction using the method of the present invention to adapt the daily spending limits of a debit instrument. FIG. 2A is a diagram illustrating an exploded view of the process flow for the Merchant Acquirer/Payment Network shown in FIG. 2. FIG. 2B is a diagram illustrating an exploded view of the process flow for the Integrated Payment Engine shown in FIG. 2.

As shown in 202 of FIG. 2, a debit transaction is initiated when a debit instrument holder 20 such as a customer of a financial institution initiates a debit instrument transaction at a terminal 30 and selects a transaction type. The debit instrument is initiated by any number of entry modes including, but not limited to, keyed and swiped. The terminal 30 is, for example, an ATM or POS terminal.

The transaction information is electronically transmitted by the terminal 30 to the merchant acquirer/payment network 40 shown in FIG. 2A. According to 204 of FIG. 2A, the transaction is sent to the merchant acquirer which validates the transaction and assesses a surcharge (if applicable) as determined by the merchant acquirer or transaction type. As shown in 206, if the debit instrument holder 20 accepts the surcharge (if applicable) and the transaction passes the edit checks, the merchant acquirer sends the transaction to a payment network for authorization. Examples of edit checks include, but are not limited to, status of the debit instrument, expiration date validity, card verification value, among others. According to 208, the payment network routes the transaction to an integrated payment engine 50. As shown in 220 of FIG. 2B, the integrated payment engine 50 performs transaction and instrument prescreen checks such as for limits, usage, personal identification number (PIN), among others using the adaptive daily spending limit methodology of the present invention. As shown in 222, it is queried whether the edit checks pass.

If the edit checks do not pass in 223, the integrated payment engine 50 sends a denial response back to the payment network 40. The integrated payment engine sends the transaction to the payment network to 236 of FIG. 2A.

If the edit checks pass, then in 224 the integrated payment engine checks routing tables to determine to which entity to route the transaction and the instruments route to the CSA 60 for authorization. In 226 of FIG. 2B, if the CSA is available, the integrated payment engine 50 sends the transaction to the CSA 60 and awaits response.

If the CSA 60 is not available, according to 230 of FIG. 2B, the integrated payment engine 50 authorizes the transaction using off-line limits. An off-line limit is, for example, a static monetary amount that all transactions are authorized against or a monetary amount that is based upon a prior balance figure that was in the account previously against which the transaction is authorized. According to 232, the integrated payment engine 50 logs the transaction to the transaction log file and then in 234 of FIG. 2B, the integrated payment engine 50 sends the response to the payment network 40. As shown in 236 of FIG. 2A, the payment network sends the transaction to the merchant acquirer. From the merchant acquirer, the transaction is sent back to the terminal 30. As shown in 238 of FIG. 2, the terminal 30 performs functions such as dispense and print among others and sends an acknowledgement back to the merchant acquirer. The terminal receives an approval or denial referral. As indicated in 240 of FIG. 2, the debit instrument transaction is complete-and the process flow ends.

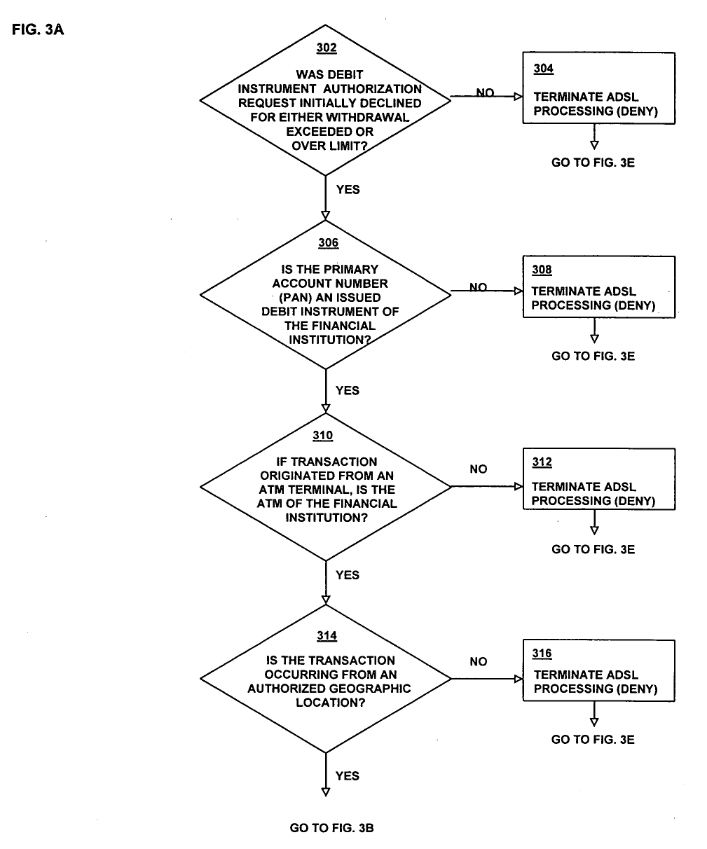

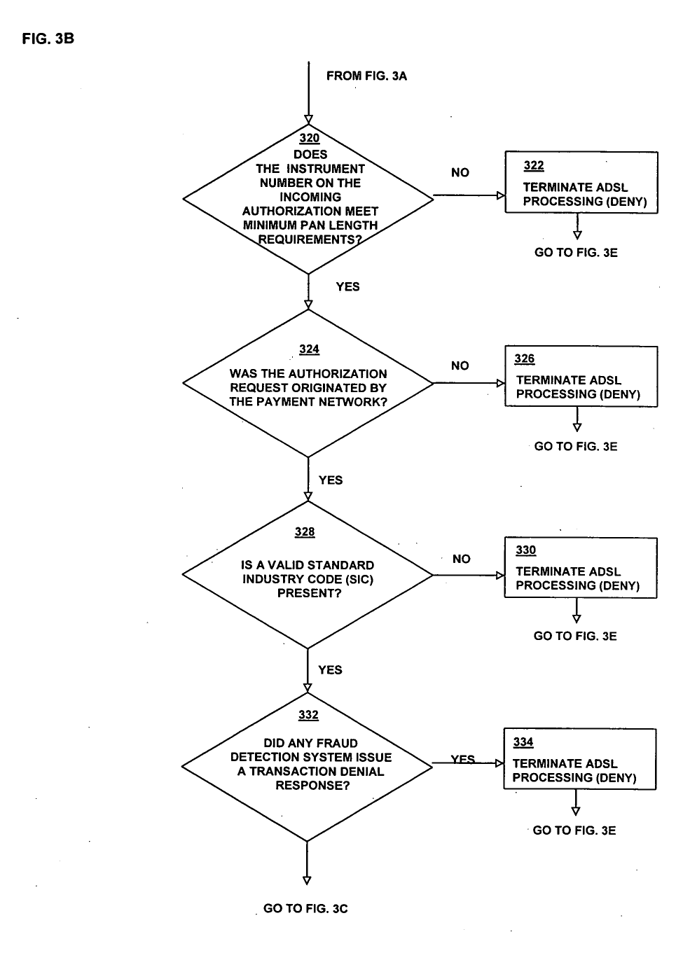

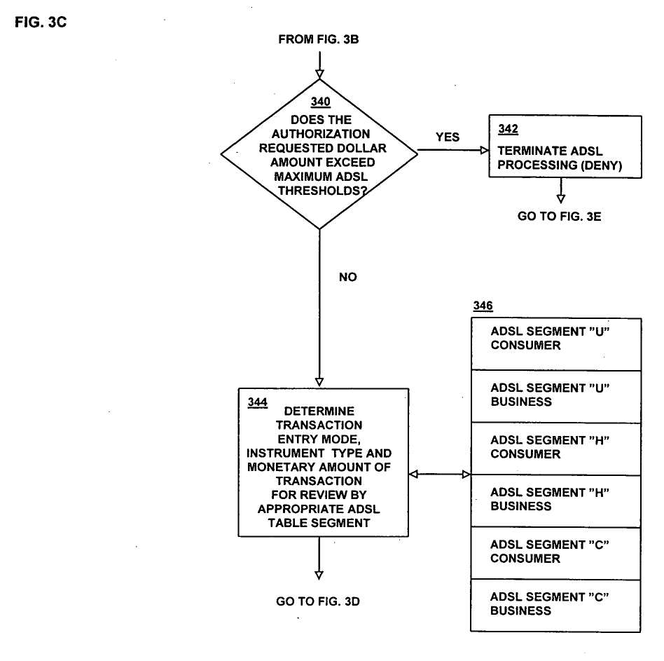

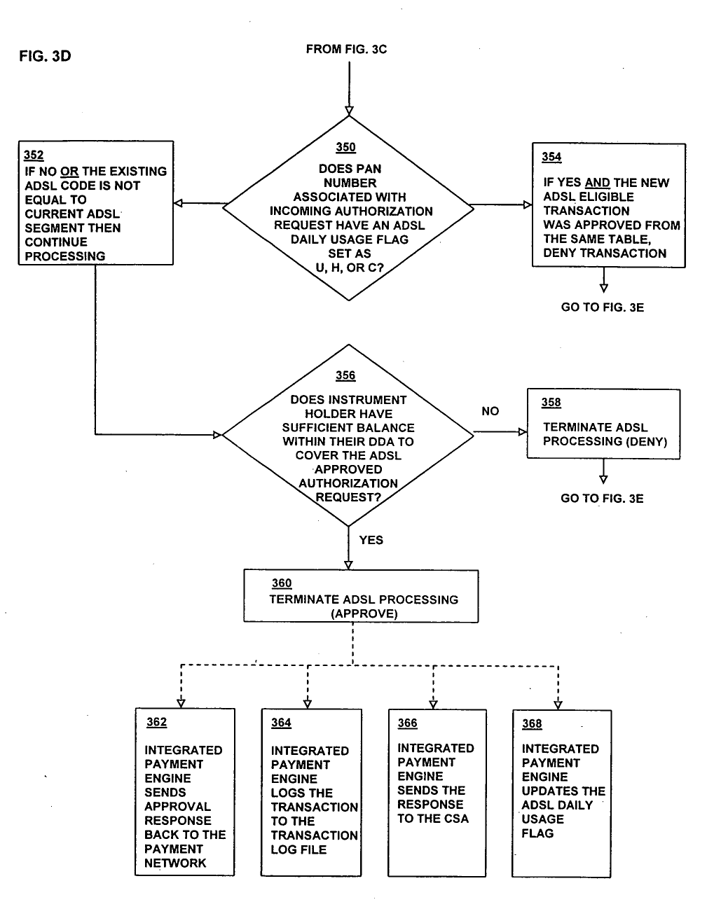

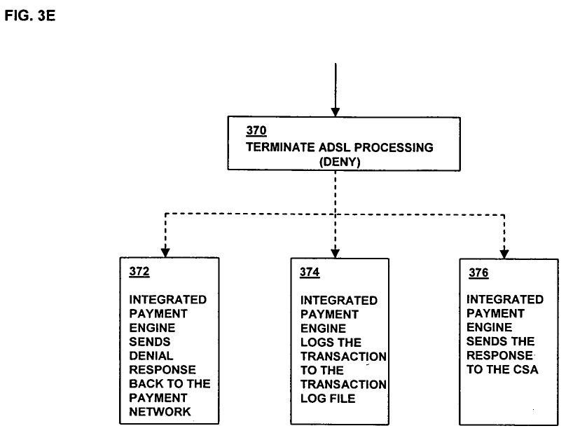

FIGS. 3A, 3B, 3C, 3D, and 3E illustrate a preferred implementation of the method of the present invention in a networked computer system of a financial institution. However, this illustrated implementation is by no means intended to limit the scope of the present invention as there are various modifications to the networked computer system and method that are within the scope of the present invention.

It is of particular note that in traditional debit instrument transactions, the debit transaction is terminated if the transaction exceeds the spending limit of the debit instrument. In contrast, the system and method the of the present invention implements its automated ADSL methodology to determine whether or not to override the spending limit on the debit instrument after a determination of the transactional risk associated with the transaction.

Referring to FIG. 3A, according to the method of the present invention, it is queried in 302 whether the debit instrument authorization request was initially declined by the integrated payment engine for exceeding the withdrawal limit or debit instrument spending limit. If the answer to the query is “No,” ADSL processing terminates and the transaction is denied as shown in 304 and routed to 370 of FIG. 3E. If the answer to the query is “Yes,” ADSL processing continues in 306.

In 306 it is queried whether the Primary Account Number (PAN) is an issued debit instrument account of the financial institution. If the answer is “No, ADSL processing terminates and the transaction is denied as shown in 308. If the answer is “Yes,” ADSL processing continues in 310.

In 310 it is queried whether the ATM from which the transaction originates is an ATM of the financial institution that issued the debit instrument. If the answer is “No,” ADSL processing terminates and the transaction is denied as shown in 312 and routed to 370 of FIG. 3E. If the answer is “Yes,” ADSL processing continues in 314.

In 314 it is queried as to whether the transaction is occurring from an authorized geographic location by, for example, checking the country code of the incoming authorization. If the answer is “No,” ADSL processing terminates and the transaction is denied as shown in 316 and routed to 370 of FIG. 3E. If the answer is “Yes,” ADSL processing continues in 320 of FIG. 3B.

In 320 it is queried whether the debit instrument number on the incoming authorization meets minimum PAN length requirements. If the answer is “No,” ADSL processing terminates and the transaction is denied as shown in 322 and routed to 370 of FIG. 3E. If the answer is “Yes,” ADSL processing continues in 324.

In 324 it is queried as to whether the authorization request was originated by the payment network. If the answer is “No,” ADSL processing terminates and the transaction is denied as shown in 326 and routed to 370 of FIG. 3E. If the answer is “Yes,” ADSL processing continues in 328.

In 328 it is queried as to whether a valid SIC code is present. If the answer is “No,” ADSL processing terminates and the transaction is denied as shown in 330 and routed to 370 of FIG. 3E. If the answer is “Yes,” ADSL processing continues in 332.

In 332 it is queried whether any fraud detection system issued a transaction denial response. If the answer is “Yes,” ADSL processing terminates and the transaction is denied as shown in 334 and routed to 370 of FIG. 3E. If the answer is “No,” ADSL processing continues in 340 of FIG. 3C.

In 340 of FIG. 3C, it is queried whether the authorization requested dollar amount exceeds maximum ADSL threshold values. If the answer is “Yes,” ADSL processing terminates and the transaction is denied as shown in 342 and routed to 370 of FIG. 3E. If “No,” ADSL processing continues in 344.

Next, in 344, the entry mode (i.e. swiped, keyed, etc.), debit instrument type, and monetary amount of the transaction are determined for review by the appropriate ADSL table segment shown in 346 of FIG. 3C. Examples of ADSL table segments include, but are not limited to, ultra dollar “U” consumer, ultra dollar “U” business, high dollar “H” consumer, high dollar “H” business, cushion dollar “C” consumer, and cushion dollar “C” business.

In FIG. 3C, after ADSL table eligibility is determined additional ADSL processing occurs in FIG. 3D. In 350, it is queried whether the PAN number associated with the incoming authorization request has an ADSL daily usage flag set as U, H or C.

As shown in 354, if the PAN number associated with the incoming authorization request has an ADSL daily usage flag set as U, H or C and the new ADSL eligible transaction was approved from the same table, then ADSL processing terminates and the transaction is denied as shown in 354 and routed to 370 of FIG. 3E. As shown in 352, if the PAN number associated with the incoming authorization request does not have an ADSL daily usage flag set as U, H or C or the existing ADSL code is not equal to the current ADSL segment, then ADSL processing continues in 356. This query is included in the instance that it is desirable to limit, for example, the debit instrument holder to only one approved authorization per ADSL segment per day, if such limitation is desired.

In 356 of FIG. 3D, it is queried whether the debit instrument holder has sufficient balance within its DDA to cover the ADSL approved authorization request. If the answer is “No,” ADSL processing terminates and the transaction is denied as shown in 358 and routed to 370 of FIG. 3E. If the answer is “Yes,” ADSL processing continues in 360.

As shown in 370 of FIG. 3E when the transaction is denied, several events occur. In 372 the integrated payment engine sends a denial response back to the payment network. In 374 the integrated payment network logs the transaction to a transaction log file. In 376 the integrated payment network sends the denial response to the CSA.

As shown in 360 of FIG. 3D when the transaction is approved, several events occur. In 362 the integrated payment engine sends an approval response back to the payment network. In 364 the integrated payment network logs the transaction to a transaction log file. In 366 the integrated payment network sends the approval response to the CSA. In 368 the integrated payment network updates the daily usage flag (i.e. U, H, or C).

The basic structure of the ADSL computer code is designed to be modular, in that additional segment tables can be added to the integrated payment engine. The ADSL table structure is also designed to be adaptive to meet dynamic business needs.

Table 1 is an example of an ADSL table for the Ultra High “U” Dollar Consumer Segment that provides a $20,000 override, for example, to the existing daily spending limit is shown below.

TABLE 1

| SIC | SIC | | | |
|---|---|---|---|---|
| Begin | End | SIC Group | Allow | Allow |
| Range | Range | Description | Keyed | Swiped |
| 0742 | 2842 | General Service | Yes | Yes |
| 3501 | 3780 | Hotels | Yes | Yes |
| 4411 | 4582 | Transportation | Yes | Yes |
| 8011 | 8099 | Medical | Yes | Yes |
| 8111 | 8111 | Legal | Yes | Yes |
| 8211 | 8299 | Schools | Yes | Yes |
| 9311 | 9311 | Tax | Yes | Yes |
| 9399 | 9399 | Government | Yes | Yes |

Table 2 is an example of an ADSL table for the Ultra High “U” Dollar Business Segment that provides a $20,000 override, for example, to the existing daily spending limit is shown below.

TABLE 2

| SIC | SIC | | | |
|---|---|---|---|---|
| Begin | End | SIC Group | Allow | Allow |
| Range | Range | Description | Keyed | Swiped |
| 0742 | 2842 | General Service | Yes | Yes |
| 3501 | 3780 | Hotels | Yes | Yes |
| 4411 | 4582 | Transportation | Yes | Yes |
| 8011 | 8099 | Medical | Yes | Yes |
| 8111 | 8111 | Legal | Yes | Yes |
| 8211 | 8299 | Schools | Yes | Yes |
| 9311 | 9311 | Tax | Yes | Yes |
| 9399 | 9399 | Government | Yes | Yes |

Table 3 is an example of an ADSL table for the High “H” Dollar Consumer Segment that provides a $10,000 override, for example, to the existing daily spending limit is shown below.

TABLE 3

| SIC | SIC | | | |
|---|---|---|---|---|
| Begin | End | SIC Group | Allow | Allow |
| Range | Range | Description | Keyed | Swiped |
| 3000 | 3299 | Airlines | Yes | Yes |
| 3351 | 3441 | Car Rental | Yes | Yes |
| 4011 | 4410 | Transportation | Yes | Yes |
| 4583 | 4789 | Transportation | Yes | Yes |
| 4899 | 4900 | Utilities | Yes | Yes |
| 5013 | 5199 | Business to | Yes | Yes |
| | | Business | | |
| 5200 | 5309 | Retail Various | No | Yes |
| 5511 | 5533 | Retail Auto | No | Yes |
| 5551 | 5599 | Retail Vehicle | No | Yes |
| 5681 | 5681 | Retail Fur | No | Yes |
| 5698 | 5698 | Retail Wig | No | Yes |
| 5712 | 5722 | Retail - Home | No | Yes |
| 5733 | 5733 | Retail Music | No | Yes |
| 5811 | 5812 | Food | Yes | Yes |
| 5937 | 5940 | Retail Various | No | Yes |
| 5944 | 5944 | Retail Jewelry | Yes | Yes |
| 5946 | 5949 | Retail Various | No | Yes |
| 5970 | 5998 | Retail Various | Yes | Yes |
| 6211 | 6513 | Various Service | Yes | Yes |
| 7011 | 7261 | Various Personal | Yes | Yes |
| | | Services | | |
| 7276 | 7296 | Various Personal | Yes | Yes |
| | | Services | | |
| 7298 | 7994 | Various | Yes | Yes |
| 7996 | 8010 | Various | Yes | Yes |
| 8100 | 8110 | Various | Yes | Yes |
| 8112 | 8210 | Various | Yes | Yes |
| 8300 | 9310 | Various | Yes | Yes |
| 9312 | 9398 | Various | Yes | Yes |

Table 4 is an example of an ADSL table for the High “H” Dollar Business Segment that provides a $10,000 override, for example, to the existing daily spending limit is shown below.

TABLE 4

| SIC | SIC | | | |
|---|---|---|---|---|
| Begin | End | SIC Group | Allow | Allow |
| Range | Range | Description | Keyed | Swiped |
| 3000 | 3299 | Airlines | Yes | Yes |
| 3351 | 3441 | Car Rental | Yes | Yes |
| 4011 | 4410 | Transportation | Yes | Yes |
| 4583 | 4789 | Transportation | Yes | Yes |
| 4899 | 4900 | Utilities | Yes | Yes |
| 5013 | 5199 | Business to | Yes | Yes |
| | | Business | | |
| 5200 | 5309 | Retail Various | No | Yes |
| 5511 | 5533 | Retail Auto | No | Yes |
| 5551 | 5599 | Retail Vehicle | No | Yes |
| 5681 | 5681 | Retail Fur | No | Yes |
| 5698 | 5698 | Retail Wig | No | Yes |
| 5712 | 5722 | Retail - Home | No | Yes |
| 5732 | 5732 | Electronics | Yes | Yes |
| 5733 | 5733 | Retail Music | No | Yes |
| 5811 | 5812 | Food | Yes | Yes |
| 5937 | 5940 | Retail Various | No | Yes |
| 5943 | 5943 | Office Supply | Yes | Yes |
| 5944 | 5944 | Retail Jewelry | Yes | Yes |
| 5946 | 5949 | Retail Various | No | Yes |
| 5970 | 5998 | Retail Various | Yes | Yes |
| 6211 | 6513 | Various Service | Yes | Yes |
| 7011 | 7261 | Various Personal | Yes | Yes |
| | | Services | | |
| 7276 | 7296 | Various Personal | Yes | Yes |
| | | Services | | |
| 7298 | 7994 | Various | Yes | Yes |
| 7996 | 8010 | Various | Yes | Yes |
| 8100 | 8110 | Various | Yes | Yes |
| 8112 | 8210 | Various | Yes | Yes |
| 8300 | 9310 | Various | Yes | Yes |
| 9312 | 9398 | Various | Yes | Yes |

Table 5 is an example of an ADSL table for the Cushion “C” Consumer Segment that provides a $200 override, for example, to the existing daily spending limit is shown below.

TABLE 5

| SIC | SIC | | | |
|---|---|---|---|---|
| Begin | End | SIC Group | Allow | Allow |
| Range | Range | Description | Keyed | Swiped |
| 5331 | 5410 | Retail Various | No | Yes |
| 5411 | 5411 | Grocery | Yes | Yes |
| 5412 | 5499 | Retail Various | No | Yes |
| 5611 | 5661 | Retail Clothing | No | Yes |
| 5691 | 5697 | Retail Clothing | No | Yes |
| 5699 | 5699 | Retail Clothing | No | Yes |
| 5734 | 5735 | Retail Various | No | Yes |
| 5813 | 5935 | Retail Various | No | Yes |
| 5941 | 5942 | Retail Various | No | Yes |
| 5945 | 5945 | Retail Toys | No | Yes |
| 5999 | 5999 | Retail | No | Yes |
| | | Miscellaneous | | |

Table 6 is an example of an ADSL table for the Cushion “C” Business Segment that provides a $200 override, for example, to the existing daily spending limit is shown below.

TABLE 6

| SIC | SIC | | | |
|---|---|---|---|---|
| Begin | End | SIC Group | Allow | Allow |
| Range | Range | Description | Keyed | Swiped |
| 5331 | 5410 | Retail Various | No | Yes |
| 5411 | 5411 | Grocery | Yes | Yes |
| 5412 | 5499 | Retail Various | No | Yes |
| 5611 | 5661 | Retail Clothing | No | Yes |
| 5691 | 5697 | Retail Clothing | No | Yes |
| 5699 | 5699 | Retail Clothing | No | Yes |
| 5734 | 5735 | Retail Various | No | Yes |
| 5813 | 5935 | Retail Various | No | Yes |
| 5941 | 5942 | Retail Various | No | Yes |
| 5945 | 5945 | Retail Toys | No | Yes |
| 5999 | 5999 | Retail | No | Yes |
| | | Miscellaneous | | |

In accordance with the present invention, it is possible to identify low risk SIC Codes. The focal point of these exclusions would be SIC codes with potential to generate high dollar transactions. Examples of these would include, but not be limited to, the following:

0742-1799—Contracted services—veterinary, landscaping, general contractors, etc.

2741-2842—Wholesale distributors—Miscellaneous publishing/printing, specialty cleaning, etc.

3XXX—Travel related—Hotels, airlines, rental cars

4XXX—Miscellaneous—Various Travel and Service

5000-5211—Business to Business and Home Supply—plumbing/heating equipment, dental/medical supplies, commercial furniture, etc.

5231-5999—Selected SIC's—retail oriented—auto dealers, motorcycle dealers, furniture, hearing aides, jewelry stores, etc.

7XXX—Variety—Travel, service related—Lodging, timeshares, funeral service, consulting management, motor home rental, etc.

8XXX—Variety—Medical, education, organization related—doctors, dentists, osteopathic, nursing services, attorneys, colleges, child care services, etc.

9XXX—Government related—Fines, taxes, bail, court costs, etc.

There are expected benefits associated with the system and method of the present invention. Among the benefits associated with the system and method of the present invention is enhanced customer satisfaction by decreasing the amount of declines issued on debit instrument purchases for exceeding the established daily spending limit. Another benefit is a significant increase in Interchange Revenue realized by a financial institution as transactions previously declined, are now approved. Another advantage is a decrease in operational expense related to handling customer inquires relating to declined authorizations. Still yet another advantage is a decrease in card association and processor expense relating to fees assessed relating to manual authorizations. An advantage of the use of adaptive daily spending limits of the present invention is to maximize risk adjusted return associated with debit instruments, namely the recognition that risk can be introduced and managed if revenue increases outweigh the incremental risk added for a given transaction.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A networked computer system for adapting the spending limit of a debit instrument, the system comprising:
a debit instrument holder having a debit instrument with a spending limit,
a terminal for use by the debit instrument holder to conduct a financial transaction with the debit instrument,
a payment network communicatively connected with the terminal, and
an integrated payment engine communicatively connected to the payment network, wherein the integrated payment engine comprises criteria for determining transactional risk associated with the financial transaction.

2. The networked computer system of claim 1, further comprising a computer software application communicatively connected to the integrated payment engine for accessing a financial account of the debit instrument holder.

3. The networked computer system of claim 1, wherein the spending limit of the debit instrument is a daily spending limit.

4. The networked computer system of claim 1, wherein the criteria is comprised in a data table in the integrated payment engine.

5. The networked computer system of claim 1, wherein the criteria is selected from the group consisting of fraud, SIC code, debit instrument entry mode, geographic location, monetary amount, and a combination thereof.

6. The networked computer system of claim 1, wherein the debit instrument is in a form of a card.

7. A method for adapting the spending limit of a debit instrument in a networked computer system, the method comprising:
receiving an electronic notification of a financial transaction conducted using a debit instrument of a debit instrument holder, and
automatically determining the transactional risk associated with the financial transaction prior to approval or denial of the financial transaction.

8. The method of claim 7, further comprising adapting the spending limit of the debit instrument after the determination of transactional risk.

9. The method of claim 7, wherein the spending limit of the debit instrument is a daily spending limit.

10. The method of claim 7, further comprising establishing computer-implemented criteria for determining the transactional risk of a debit instrument transaction.

11. The method of claim 10, wherein the criteria is selected from the group consisting of fraud, debit instrument entry mode, SIC code, monetary amount, geographic location, and a combination thereof.

12. The method of claim 10, further comprising generating a data table for electronically storing the criteria associated with the debit instrument transaction.

13. The method of claim 11, wherein the data table comprises data directed to a segment of debit instrument transactions.

14. The method of claim 13, wherein the segment is based upon a monetary value of the debit instrument transaction.

15. The method of claim 13, wherein the segment is based upon a level of fraud associated with a debit instrument transaction.

16. The method of claim 13, wherein the segment is further classified based upon business use.

17. The method of claim 13, wherein the segment is further classified based upon consumer use.

18. A method for adapting the spending limit of a debit instrument in a networked computer system, the method comprising:
determining whether an electronic request to approve a debit instrument transaction was declined for exceeding a withdrawl limit or a spending limit, and
determining transactional risk associated with the debit instrument transaction using computer-implemented criteria.

19. The method of claim 18, further comprising adapting the spending limit of the debit instrument after the determination of transactional risk.

20. The method of claim 18, wherein the withdrawl limit or spending limit is a daily spending limit.

21. The method of claim 18, wherein the criteria is selected from the group consisting of fraud, debit instrument entry mode, SIC code, monetary amount, geographic location, and a combination thereof.

22. The method of claim 18, further comprising generating a data table for electronically storing the criteria associated with the debit instrument transaction.

23. The method of claim 22, wherein the data table comprises data directed to a segment of debit instrument transactions.

24. The method of claim 23, wherein the segment is based upon a monetary value.

25. The method of claim 23, wherein the segment is based upon a level of fraud.

26. The method of claim 23, wherein the segment is further classified based upon business use.

27. The method of claim 23, wherein the segment is further classified based upon consumer use.

28. A networked computer system, the system comprising:
a means for determining transactional risk associated with a financial transaction initiated with a debit instrument having a spending limit, and
a means for adapting the spending limit of the debit instrument based upon the determination of transactional risk.

29. A method for processing debit instrument transactions in a networked computer system, the improvement comprising adapting a spending limit of a debit instrument-after an automated determination of transactional risk associated with the debit instrument transaction.
